(19) United States
(12) Patent Application Publication
(10) Pub. No.: US 2026/0201517 A1
(43) Pub. Date: Jul. 16, 2026

(54) ALLOY

(71) Applicants: TOHOKU MAGNET INSTITUTE CO., LTD., Miyagi (JP); NATIONAL INSTITUTE FOR MATERIALS SCIENCE, Ibaraki (JP)

(72) Inventors: Shozo HIRAMOTO, Sendai-shi (JP); Takayuki MIYATAKE, Kobe-shi (JP); Ravi GAUTAM, Tsukuba-shi (JP); Hossein SEPEHRI AMIN, Tsukuba-shi (JP); Tadakatsu OHKUBO, Tsukuba-shi (JP)

(73) Assignee: AISIN CORPORATION, Kariya, Aichi (JP)

(21) Appl. No.: 19/137,093

(22) PCT Filed: Nov. 28, 2023
(86) PCT No.: PCT/JP2023/042606

§ 371 Date: Jun. 9, 2025

(30) Foreign Application Priority Data
Dec. 9, 2022 (JP) 2022-197219

(51) Int. Cl. C22C 38/16; C21D 6/00; C21D 9/52; C22C 38/00; C22C 38/02; H01F 1/153

(52) U.S. Cl. CPC C22C 38/16; C21D 6/008; C21D 9/52; C22C 38/002; C22C 38/02; H01F 1/153; C21D 2201/03; C22C 2200/04; C22C 2202/02

(57) ABSTRACT

An alloy contains Fe and B, and includes an amorphous phase and a plurality of a-Fe crystalline phases formed in the amorphous phase, in which an average Fe concentration in the entire alloy is 79 atom % or more, and a degree of crystallinity measured using an X-ray diffraction method is 0.3% or more and 20% or less.

### TECHNICAL FIELD

The present invention relates to an alloy, for example, an alloy containing a nanocrystalline soft magnetic material containing Fe.

### BACKGROUND ART

A nanocrystalline alloy includes a plurality of nano-sized crystalline phases (nanocrystalline phases) formed in an amorphous phase. Fe—Si—B—Nb—Cu alloys and Fe—Cu—P—B—Si alloys are known as soft magnetic materials (e.g., Patent Literature 1).

### CITATIONS LIST

### Patent Literature

Patent Literature 1: WO 2021/132272 A

### SUMMARY OF INVENTION

### Technical Problems

The Fe—Cu—P—B—Si alloy has a higher saturation magnetic flux density than the Fe—Si—B—Nb—Cu alloy, but has a larger iron loss than the Fe—Si—B—Nb—Cu alloy.

The present invention has been made in view of the above problem, and an object thereof is to provide an alloy having a high saturation magnetic flux density and a small iron loss.

### Solutions to Problems

The present invention relates to an alloy that contains Fe and B, and includes an amorphous phase and a plurality of a-Fe crystalline phases formed in the amorphous phase, in which an average Fe concentration in the entire alloy is 79 atom % or more, and a degree of crystallinity measured using an X-ray diffraction method is 0.3% or more and 20% or less.

In the above configuration, the average Fe concentration in the entire alloy may be 79.0 atom % or more and 86.0 atom % or less, an average B concentration in the entire alloy may be 5.0 atom % or more and 14.0 atom % or less, an average Si concentration in the entire alloy may be 0.0 atom % or more and 8.0 atom % or less, an average P concentration in the entire alloy may be 0.0 atom % or more and 8.0 atom % or less, an average C concentration in the entire alloy may be 0.0 atom % or more and 5.0 atom % or less, and an average Cu concentration in the entire alloy may be 0.0 atom % or more and 1.4 atom % or less.

In the above configuration, an average impurity concentration of impurities other than Fe, Cu, P, B, Si, and C in the entire alloy may be 0 atom % or more and 0.3 atom % or less, and the sum of the average Fe concentration, the average Cu concentration, the average P concentration, the average B concentration, the average Si concentration, the average C concentration, and the average impurity concentration may be 100.0 atom %.

In the above configuration, the average Fe concentration in the entire alloy may be 79.0 atom % or more and 86.0 atom % or less, the average B concentration in the entire alloy may be 5.0 atom % or more and 14.0 atom % or less, the average Si concentration in the entire alloy may be 0.0 atom % or more and 8.0 atom % or less, the average P concentration in the entire alloy may be 1.0 atom % or more and 8.0 atom % or less, the average C concentration in the entire alloy may be 0.0 atom % or more and 5.0 atom % or less, and the average Cu concentration in the entire alloy may be 0.4 atom % or more and 1.4 atom % or less.

In the above configuration, a ratio of the average Cu concentration to the average P concentration may be 0.08 or more and 0.8 or less.

In the above configuration, an average impurity concentration of impurities other than Fe, Cu, P, B, Si, and C in the entire alloy may be 0 atom % or more and 0.3 atom % or less, and the sum of the average Fe concentration, the average Cu concentration, the average P concentration, the average B concentration, the average Si concentration, the average C concentration, and the average impurity concentration may be 100.0 atom %.

In the above configuration, an electrical resistivity of the alloy may be 0.65 times or more an electrical resistivity of an alloy having the degree of crystallinity of 0%.

In the above configuration, the degree of crystallinity may be 0.5% or more and 8% or less.

In the above configuration, the alloy may have a powder shape or a strip shape.

### Advantageous Effects of Invention

According to the present invention, it is possible to provide an alloy having a high saturation magnetic flux density and a small iron loss.

### BRIEF DESCRIPTION OF DRAWINGS

FIGS. 1A to 1C are views illustrating powder, a thin strip, and a magnetic component according to a first embodiment.

FIG. 2 is a diagram showing temperature changes during conveyance of samples PA02, PA03, and PA06.

FIG. 3 is a diagram showing a correlation between a degree of crystallinity evaluated by using an X-ray diffraction (XRD) method and a degree of crystallinity evaluated by using a differential scanning calorimetry (DSC) method.

FIGS. 4A and 4B are transmission electron microscope (TEM) images and selected area electron diffraction (SAED) images of samples PA01 and PA06, respectively.

FIGS. 5A and 5B are TEM images and SAED images of samples PA03 and PA02, respectively.

FIG. 6A is a diagram showing an electrical resistivity with respect to an XRD degree of crystallinity, while FIG. 6B is a diagram showing an iron loss W10/10k at a maximum applied magnetic field Bm=1 T and a frequency f=10 kHz with respect to the XRD degree of crystallinity.

FIG. 7A is a diagram showing a saturation magnetic flux density Bs with respect to the XRD degree of crystallinity, while FIG. 7B is a diagram showing a coercivity Hc with respect to the XRD degree of crystallinity.

FIG. 8 is a diagram showing normalized electrical resistivities with respect to the XRD degrees of crystallinity in samples G4, G12, FeB, and AMH1.

FIGS. 9A and 9B are diagrams showing normalized W10/10ks with respect to the XRD degrees of crystallinity.

### DESCRIPTION OF EMBODIMENTS

The Fe—Si—B—Nb—Cu alloy can realize a high magnetic permeability and a low iron loss, and has good soft magnetic properties. However, a saturation magnetic flux density Bs is about 1.23 T. Therefore, when this alloy is used for electronic components, there is a disadvantage that applicable components and equipment can be increased in size. On the other hand, the Fe—Cu—P—B—Si alloy has a high saturation magnetic flux density, but has a large iron loss. Therefore, it is difficult to use the Fe—Cu—P—B—Si alloy for high-frequency electronic components. In particular, miniaturization and high power density of power control equipment have recently advanced with the progress of power semiconductors. As a result, there is a demand for electronic components having a smaller loss (particularly, a smaller iron loss) for high frequencies such as several kHz to 10 MHz. In the Fe—Cu—P—B—Si alloy, the degree of crystallinity is generally 40% to 50%. With this degree of crystallinity, the saturation magnetic flux density of the alloy can be increased, but the iron loss is large.

An iron loss Pe is generally considered to be the sum of a hysteresis loss and an eddy current loss. The eddy current loss is expressed by a mathematical equation 1.

$$[ Mathematical equation 1 ]$$

$${P}_{e} = \frac{C {B}^{2} {f}^{2} {d}^{2}}{ρ}$$

B is a magnetic flux density, f is a frequency, d is a thickness of the alloy, ρ is an electrical resistivity, and C is a constant. From the mathematical equation 1, the higher the frequency, the larger the iron loss. Therefore, electronic components for high-frequency applications are required to further suppress the iron losses caused by eddy currents. The lower the electrical resistivity, the larger the eddy current loss. Therefore, in order to suppress the iron loss, it is required to increase the electrical resistivity. In the nanocrystalline alloy, the electrical resistivity of a crystalline phase, which is iron (α-Fe) having a body-centered cubic (BCC) structure, is low. Therefore, it is considered that when the degree of crystallinity in the alloy decreases, the electrical resistivity may increase and the iron loss may be suppressed.

A method for producing an amorphous alloy and the nanocrystalline alloy will be described. First, an amorphous alloy (precursor alloy) is formed by rapidly cooling a liquid metal obtained by melting a mixture of materials. The amorphous alloy contains almost entirely an amorphous phase and little to no crystalline phase. Depending on the conditions of rapid cooling the liquid metal, the amorphous alloy may contain a trace amount of crystalline phase. Next, the amorphous alloy is heat-treated. The amorphous alloy is heated to a higher temperature than a temperature at which the crystalline phase, which is α-Fe, starts to be generated. Thereafter, the alloy is cooled, whereby a part of the amorphous alloy becomes the crystalline phase.

### First Embodiment

An alloy of a first embodiment contains Fe (iron) and B (boron), and includes an amorphous phase and a plurality of α-Fe crystalline phases formed in the amorphous phase. The degree of crystallinity measured using an X-ray diffraction method is 0.3% or more and 20% or less. This makes it possible to suppress the iron loss. The alloy preferably contains Fe (iron), Si (silicon), B (boron), P (phosphorus), and Cu (copper). This makes it possible to increase the saturation magnetic flux density and suppress the iron loss.

### [Degree of Crystallinity and Electrical Resistivity]

The degree of crystallinity is measured by an X-ray diffraction (XRD) method. The XRD degree of crystallinity can be measured as follows. As an X-ray source, for example, a Cu tube or a Cr (chromium) tube is used. When the amorphous alloy (precursor alloy) is subjected to XRD measurement, a broad peak derived from amorphous (amorphous) is observed in the vicinity of 2θ=45° in the case of a Cu tube, and in the vicinity of 2θ=69° in the case of a Cr tube. In the case of a sample with advanced crystallization, a (110) diffraction peak derived from BCC—Fe is observed in the vicinity of 2θ=45° in the case of a Cu tube, and in the vicinity of 2θ=69° in the case of a Cr tube. The degree of crystallinity can be determined by determining a ratio between a broad diffraction intensity due to the amorphous and a sharp diffraction intensity due to the crystal. The integrated intensity by diffraction is calculated by fitting using a peak shape function. The peak shape function can be arbitrarily selected from a Gaussian function, a Lorentzian function, a pseudo-Voigt function, a Pearson VII function, and the like. Each parameter of the peak shape function is refined using the least squares method to derive the integrated intensity of the peak. When it is assumed that the integrated intensity of the (110) diffraction peak is Ic and the integrated intensity of the broad peak derived from amorphous is Ia, the degree of crystallinity is derived as Ic/(Ic+Ia).

The degree of crystallinity may be measured using a differential scanning calorimetry (DSC) method and converted into a degree of crystallinity measured by an X-ray diffraction method. In the DSC method, when the alloy is scanned from 200° C. to 600° C. at 40° C./min, two exothermic peaks are observed. The peak around 400° C. is an exothermic peak due to precipitation of BCC—Fe, while the peak around 500° C. is an exothermic peak due to precipitation of a boron compound such as diiron boride. Here, the calorific value by BCC—Fe around 400° C. is defined as ΔH1. When a sample with advanced crystallization is measured by DSC, ΔH1 decreases more than the ΔH1 of the amorphous alloy (precursor alloy). By taking a ratio between the ΔH1 of the amorphous alloy (precursor alloy) and the ΔH1 of the crystallized sample, the remaining amount of the crystallizable BCC—Fe can be known. The degree of crystallinity is derived as 1−ΔH1 (crystallized alloy)/ΔH1 (amorphous alloy). For example, when a degree of crystallinity measured using a DSC method is multiplied by 0.45, the degree of crystallinity can be converted into a degree of crystallinity measured by an XRD method.

When the degree of crystallinity is 0%, the alloy is almost entirely an amorphous phase, and has a large iron loss and a small saturation magnetic flux density. When the degree of crystallinity is more than 20%, the iron loss is almost the same as when the degree of crystallinity is 0%. When the degree of crystallinity is more than 0%, the iron loss is suppressed. The iron loss when the degree of crystallinity is 0.3% or more reduces more than the iron loss when the degree of crystallinity is 0%. When the degree of crystallinity is 0.5% or more, the iron loss further reduces. When the degree of crystallinity is 0.5% to 6%, the iron loss is small and remains nearly constant. When the iron loss is 8%, the iron loss slightly increases. When the degree of crystallinity is more than 20%, the iron loss is almost the same as when the degree of crystallinity is 0%.

The electrical resistivity of the alloy is measured using the four-probe method of JIS (Japanese Industrial Standard) K7194. The electrical resistivity of the alloy decreases as the degree of crystallinity increases. When the degree of crystallinity increases from 0% to 0.3%, the electrical resistivity becomes approximately 0.88 times the electrical resistivity when the degree of crystallinity is 0%. When the degree of crystallinity is 5%, the electrical resistivity becomes approximately 0.82 times the electrical resistivity when the degree of crystallinity is 0%. When the degree of crystallinity is 18%, the electrical resistivity becomes approximately 0.68 times the electrical resistivity when the degree of crystallinity is 0%. As the degree of crystallinity increases, the electrical resistivity decreases and the iron loss increases, as described above. From the above, the electrical resistivity of the alloy is preferably 0.65 times or more, more preferably 0.7 times or more, and even more preferably 0.8 times or more, based on the electrical resistivity of the alloy having a degree of crystallinity of 0%. When the electrical resistivity is high, the crystallinity is almost 0%. Therefore, the electrical resistivity of the alloy is preferably 0.95 times or less, and more preferably 0.9 times or less, based on the electrical resistivity of the alloy having a degree of crystallinity of 0%.

From the above, the degree of crystallinity is 0.3% or more, preferably 0.5% or more, more preferably 1% or more, and even more preferably 2% or more. The degree of crystallinity is 20% or less, preferably 18% or less, more preferably 10% or less, and even more preferably 8% or less. The electrical resistivity is preferably 0.65 times or more, more preferably 0.8 times or more, and even more preferably 0.85 times or more, based on the electrical resistivity of an alloy having a degree of crystallinity of 0% and having the same composition.

### [Composition]

The alloy of the first embodiment contains Fe and B, and may contain Si, P, and Cu. C (carbon) may be contained intentionally or unintentionally. Impurity elements other than Fe, Si, B, P, Cu, and C may be unintentionally contained. The impurity is at least one element of, for example, Ti (titanium), Al (aluminum), Zr (zirconium), Hf (hafnium), Nb (neodymium), Ta (tantalum), Mo (molybdenum), W (tungsten), Cr (chromium), V (vanadium), Co (cobalt), Ni (nickel), Mn (manganese), Ag (silver), Zn (zinc), Sn (tin), Pb (lead), As (arsenic), Sb (antimony), Bi (bismuth), S (sulfur), N (nitrogen), O (oxygen), and a rare earth element.

The average Fe concentration, Si concentration, B concentration, P concentration, Cu concentration, C concentration, and impurity concentration in the entire alloy are defined as CFe, CSi, CB, CP, CCu, CC, and CI, respectively. The sum of the CFe, CSi, CB, CP, CCu, CC, and CI is 100.0 atom %. The CFe, CSi, CB, CP, CCu, CC, and CI correspond to the chemical compositions of the amorphous alloy and nanocrystalline alloy. That is, when the composition of the entire alloy is assumed as FeaBbSicPxCyCuz, the CFe, CSi, CB, CP, CCu, and CC correspond to a, c, b, x, z, and y, respectively. The average concentration of each element in the entire alloy can be measured by using the following method for a range sufficiently larger than the crystalline phase. The CSi, CB, CP, and CCu are measured using inductively coupled plasma (ICP). The CC is measured using a combustion method. The CFe is calculated as the remainder of the CSi, CB, CP, CCu, and CC. When the presence of the impurities can be confirmed by the ICP, the CI is measured using a method corresponding to the detected element.

From the viewpoint of increasing the saturation magnetic flux density, the CFe is 79.0 atom % or more, preferably 80.0 atom % or more, and more preferably 81.0 atom % or more. By increasing the concentrations of metalloids (B, P, C, and Si), the amorphous phase can be more stably provided between the crystalline phases. Therefore, the CFe is preferably 86.0 atom % or less, and more preferably 85.0 atom % or less. When a liquid metal obtained by melting a mixture of materials is rapidly cooled to prepare a thin strip of an amorphous alloy, a stable amorphous alloy cannot be obtained if the CFe exceeds 86.0 atom %. Also from this viewpoint, the CFe is preferably 86.0 atom % or less.

When the CB is high, an amorphous phase can be stably formed. Therefore, the CB is preferably 5.0 atom % or more, more preferably 6.0 atom % or more, and even more preferably 7.0 atom % or more. In order to increase the CB and to set the CFe to 79.0 atom % or more, the CP should be reduced. If the CP is too low, the coercivity increases. When the CB increases, the production temperature of an undesirable compound lowers, and the formation of a homogeneous nanocrystalline phase is inhibited, which may deteriorate magnetic properties. Therefore, the CB is preferably 14.0 atom % or less, more preferably 13.0 atom % or less, even more preferably 12.0 atom % or less, and still more preferably 11.0 atom % or less.

The alloy may not contain Si (i.e., the CSi should be 0.0 atom % or more). Increasing the CSi improves the ability to form an amorphous phase and stabilizes the preparation of an amorphous alloy by rapidly cooling a liquid metal. In addition, the temperature at which crystalline phases of a compound start to be generated rises, and the nanocrystalline phases can be stably formed. Therefore, in order to raise this temperature, the CSi is preferably more than 0.0 atom %, more preferably 0.2 atom % or more, and even more preferably 0.4 atom % or more. In order to increase the CSi and to set the CFe to 79.0 atom % or more, the CP should be reduced. If the CP is too low, the coercivity increases. Therefore, the CSi is preferably 8.0 atom % or less, more preferably 7.0 atom % or less, and even more preferably 6.0 atom % or less.

The alloy may not contain P (i.e., the CP should be 0.0 atom % or more). When the CP is high, the crystalline phase becomes small and the coercivity decreases. Therefore, the CP is preferably 1.0 atom % or more, more preferably 2.0 atom % or more, and even more preferably 3.0 atom % or more. In order to increase the CP and to set the CFe to 79.0 atom % or more, the CB and CSi should be reduced. If the CB and CSi are too low, it becomes difficult to stably form the amorphous phase. Therefore, the CP is preferably 8.0 atom % or less, more preferably 7.0 atom % or less, and even more preferably 6.0 atom % or less.

The alloy may not contain Cu (i.e., the CCu should be 0.0 atom % or more). By adding Cu to the alloy, a Cu cluster serves as a nucleation site in the initial stage of forming the crystalline phase, whereby the crystalline phase is formed. Therefore, the CCu is preferably 0.4 atom % or more, more preferably 0.5 atom % or more, and even more preferably 0.6 atom % or more. The presence of Cu clusters in the crystalline phase and the amorphous phase hinders the movement of a magnetic domain wall. In addition, when Cu is dissolved in the crystalline phase and the amorphous phase, the quantum mechanical interaction between an Fe atom and a Cu atom increases. As a result, the saturation magnetic flux density decreases. From these viewpoints, the CCu is preferably 1.4 atom % or less, more preferably 1.3 atom % or less, and even more preferably 1.2 atom % or less.

Addition of a trace amount of C is beneficial for forming the amorphous alloy, but excessive addition leads to embrittlement of the alloy and deterioration of the properties. Therefore, the CC is 0 atom % or more, preferably 5.0 atom % or less, more preferably 4.0 atom % or less, and even more preferably 3.0 atom % or less. It is preferable that impurities be not intentionally added. Therefore, the CI is 0 atom % or more, preferably 0.3 atom % or less, more preferably 0.2 atom % or less, and even more preferably 0.1 atom % or less. Each of the impurity elements is also preferably 0 atom % or more and 0.10 atom % or less, and more preferably 0 atom % or more and 0.02 atom % or less.

There is an attractive force between a Cu atom and a P atom, and when an alloy composition contains a specific ratio of a Cu element and a P element, homogeneous Fe crystals are obtained during the formation of the nanocrystalline phase, which can realize excellent magnetic properties. The ratio of the CCu to the CP (CCu/CP ratio) is preferably 0.8 or less, more preferably 0.7 or less, and even more preferably 0.6 or less in consideration of oxidation and embrittlement of the composition. The CCu/CP ratio is preferably 0.08 or more, and more preferably 0.1 or more.

The size (particle size) of the crystalline phase in the nanocrystalline alloy affects soft magnetic properties such as coercivity. When the size of the crystalline phase is small, the coercivity reduces and the soft magnetic properties are improved. Therefore, the mean equivalent spherical diameter of the crystalline phase is, for example, preferably 50 nm or less, more preferably 30 nm or less, and even more preferably 20 nm or less. The mean equivalent sphere diameter of the crystalline phase 12 is, for example, 5 nm or more.

### [Production Method]

Hereinafter, a method for producing a nanocrystalline alloy will be described. The method for producing the alloy according to the embodiment is not limited to the following method.

### [Method for Producing Amorphous Alloy]

For the production of the amorphous alloy, for example, a single roll method is used. The conditions of the roll diameter and rotation speed in the single roll method are arbitrary. The single roll method is suitable for producing an amorphous alloy because it is easy to rapidly cool. For the cooling rate of the alloy melted for producing the amorphous alloy, a method other than the single roll method may be used for producing the amorphous alloy. For producing the amorphous alloy, for example, a water atomization method or the atomization method described in Japanese Patent No. 6533352 may be used.

### [Method for Producing Nanocrystalline Alloy]

The nanocrystalline alloy is obtained by heat treatment of the amorphous alloy. In producing the nanocrystalline alloy, the temperature history in the heat treatment affects the nanostructure of the nanocrystalline alloy. In the heat treatment, for example, a heating rate, a holding temperature, the length of a holding period, and a cooling rate mainly affect the degree of crystallinity. In particular, the holding temperature most affects the degree of crystallinity. The maximum holding temperature is set to achieve a desired degree of crystallinity. The holding temperature is, for example, 200° C. or higher and 450° C. or lower. The heating rate from room temperature to the holding temperature is preferably 10° C./min or more, and more preferably 20° C./min or more. The length of the holding period is preferably a time during which it can be determined that crystallization has sufficiently progressed. For example, the length of the holding period is preferably 1 second or more, and more preferably 5 seconds or more. From the viewpoint of shortening the production time, the length of the holding period is preferably 1 hour or less. The cooling rate from the attained maximum holding temperature to room temperature is preferably 0.2° C./sec or more. The conditions of the heating rate, holding temperature, holding time, and cooling rate in the heat treatment can be selected in consideration of the sizes of the members to be applied and the like, under which crystallization can be properly realized.

### Second Embodiment

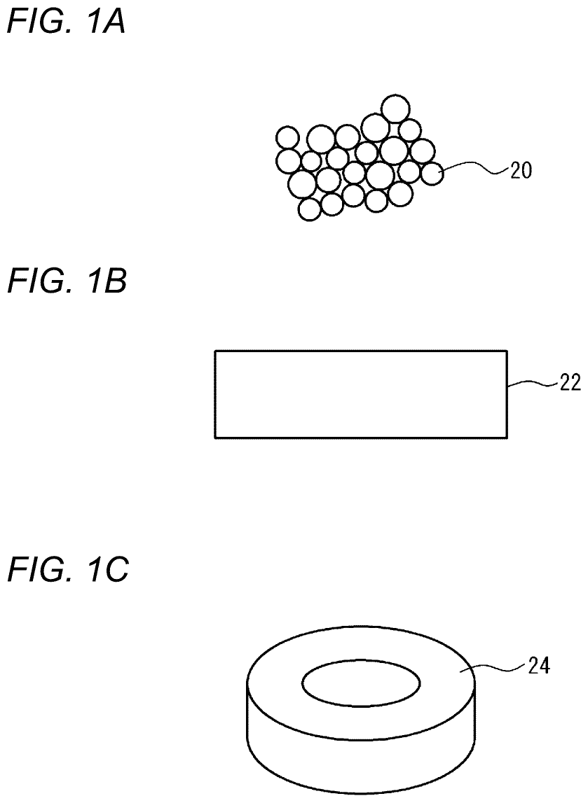

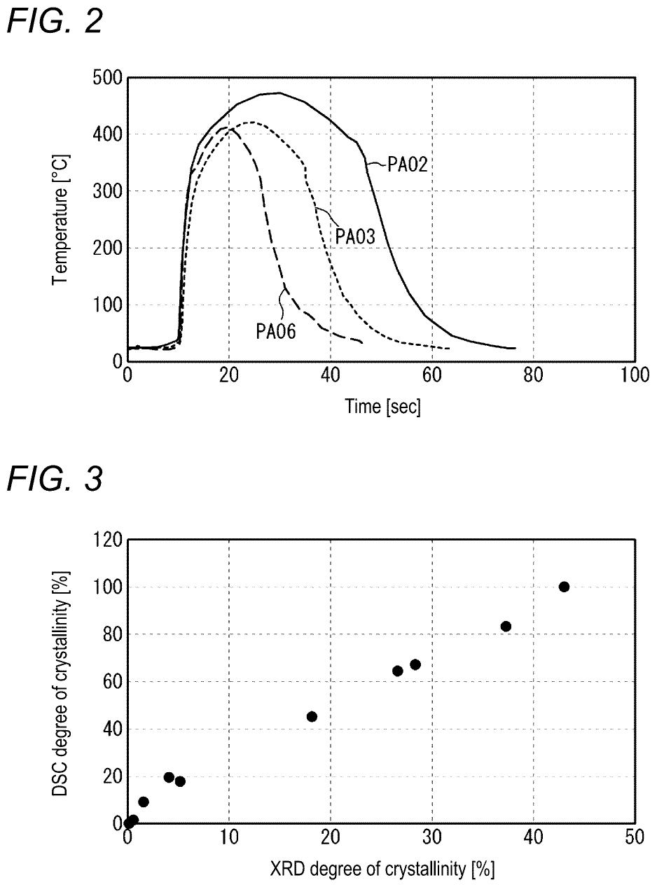

FIGS. 1A to 1C are views illustrating powder, a thin strip, and a magnetic component according to the first embodiment. As illustrated in FIG. 1A, powder 20 may contain the alloy according to the first embodiment. The particle size of the powder 20 is evaluated by a median diameter from a particle size distribution obtained by a laser diffraction/scattering method. The D90 of the powder 20 is, for example, 3 μm to 100 μm; the D50 of the powder 20 is, for example, 2 to 50 μm; and the D10 of the powder 20 is, for example, 0.5 to 20 μm. As illustrated in FIG. 1B, a thin strip 22 may contain the alloy according to the embodiment. The width of the thin strip 22 is, for example, 1 to 500 mm, and the thickness is, for example, 8 to 60 μm. As illustrated in FIGS. 1A and 1B, the alloy may have a powder shape or a strip shape. As illustrated in FIG. 1C, a soft magnetic core 24 may contain the alloy according to the first embodiment. The soft magnetic core 24 is a molded body obtained by molding a mixture containing, for example, the powder of FIG. 1A and a binder. The binder is preferably made of a resin. The molded body may be a magnetic component other than the soft magnetic core 24.

### Example 1

A sample was prepared as follows.

### [Production of Amorphous Alloy]

As starting materials of the alloy, reagents, such as iron (0.01 wt % or less of impurities), boron (less than 0.5 wt % of impurities), triiron phosphide (less than 1 wt % of impurities), copper (less than 0.01 wt % of impurities), and metallic silicon (less than 0.00001 wt % of impurities), were prepared. In the process of producing a nanocrystalline alloy from a mixture of these reagents, it was confirmed in advance that loss or mixing of elements did not occur.

200 grams of the mixture was prepared to have a desired chemical composition. The mixture was heated in a crucible in an argon atmosphere to form a uniform molten metal. The molten metal was solidified in a copper mold to produce an ingot.

An amorphous alloy was produced from the ingot using a single roll method. 20 grams of the ingot was melted in a BN (boron nitride) crucible and ejected from a quartz nozzle having an opening of 10 mm×0.3 mm to a rotating roll of pure copper. An amorphous ribbon having a width of 10 mm and a thickness of 25 μm was formed as an amorphous alloy on the rotating roll. The amorphous ribbon was removed from the rotating roll by an argon gas jet. Using an X-ray diffractometer, it was confirmed by the above-described method that the amorphous ribbon was an amorphous alloy composed only of an amorphous phase.

### [Production Apparatuses]

For the heat treatment for heat-treating the amorphous alloy to form a nanocrystalline alloy, the following two apparatuses were used.
Apparatus A: Roll-to-roll heat treatment furnace
Apparatus B: Tube furnace
[Method for MeasuringDegree of Crystallinity by XRD Method (XRDDegree of Crystallinity)]
Measuring apparatus: MiniFlex600 manufactured by Rigaku Corporation
X-ray source: Cu
2θ range: 20° to 110°
2θ scan step: 0.01°
Sample size: 10 mm×70 mm
Measurement surface: Roll surface

### [Method for MeasuringDegree of Crystallinity by DSC Method (DSCDegree of Crystallinity)]

Measuring apparatus: DSC8500 manufactured by PerkinElma, Inc.
Flow gas: Ar
Sample pan: Pt
Temperature scanning conditions: held at 200° C. for 1 minute, then heated from 200° C. to 600° C. at a rate of +40° C./min
Sample mass: about 10 mg

### [Method for Measuring Iron Loss]

Measuring apparatus: SY-8219, SY-956 manufactured by IWATSU ELECTRIC CO., LTD.
Primary winding: 40 T
Secondary winding: 200 T
Frequency: 10 kHz
Magnetic flux density: 1.0 T
Sample size: 10 mm×70 mm

### [Method for Measuring Saturation Magnetic Flux Density]

Measuring apparatus: VSM-P7-15 manufactured by Toei Industry Co., Ltd.
Applied magnetic field: 955 kA/m
Sample size: 8 mm×8 mm

### [Method for Measuring Coercivity]

Measuring apparatus: BHS-40 manufactured by Riken Denshi Co., Ltd.
Applied magnetic field: 2000 A/m
Sample size: 10 mm×70 mm

### [Method for Measuring Electrical Resistivity]

Measuring apparatus: Loresta-AX MCP-T370 manufactured by Nittoseiko Analytech Co., Ltd.

Samples were prepared using the apparatus A. Table 1 is a table showing the composition of the prepared alloy in atom % and mass %.

TABLE 1

| | Fe | Si | B | P | Cu | C |
|---|---|---|---|---|---|---|
| [atom %] | 84.8 | 0.5 | 9.4 | 3.4 | 0.8 | 1.2 |
| [mass %] | 94.4 | 0.3 | 2.0 | 2.1 | 1.0 | 0.3 |

As shown in Table 1, the CFe, CSi, CB, CP, CCu and CC, which are concentrations of Fe, Si, B, P, Cu, and C, are 84.8 atom %, 0.5 atom %, 9.4 atom %, 3.4 atom %, 0.8 atom %, and 1.2 atom %, respectively.

Table 2 is a table showing preparation conditions of the prepared samples, degree of crystallinity, electrical resistivity, W10/10k, coercivity Hc, and saturation magnetic flux density Bs. “-” in Table 2 indicates that measurement is not performed. The samples PA01 and AsQ are in an amorphous alloy state and are not subjected to heat treatment.

TABLE 2

| | Heater | Conveying | XRD degree of | DSC degree of | Electrical | | | |
|---|---|---|---|---|---|---|---|---|
| | temperature | speed | crystallinity | crystallinity | resistivity | W10/10k | Hc | Bs |
| Sample | [° C.] | [m/min] | [%] | [%] | [μΩ · cm] | [W/kg] | [A/m] | [T] |
| PA01 | 25 | — | 0.0 | 0.0 | 165.4 | 191.8 | 4.32 | 1.59 |
| PA02 | 485 | 1.0 | 43.0 | 100.0 | 94.0 | 136.7 | 3.57 | 1.76 |
| PA03 | 435 | 1.5 | 26.6 | 64.4 | 125.6 | 173.3 | 5.36 | 1.70 |
| PA06 | 425 | 2.5 | 5.1 | 17.8 | 155.8 | 79.9 | 3.99 | 1.61 |
| AsQ | 25 | — | 0.0 | 0.0 | 170.3 | 165.8 | 4.23 | 1.59 |
| PA06-a | 415 | 2.5 | 0.5 | 1.5 | 151.0 | 80.7 | 3.48 | — |
| PA06-b | 420 | 2.5 | 1.5 | 8.9 | 150.6 | 89.1 | 3.81 | — |
| PA06-c | 425 | 2.5 | 4.0 | 19.5 | 145.9 | 83.3 | 4.31 | — |
| PA06-d | 430 | 2.5 | 18.1 | 45.1 | 115.9 | 142.9 | 4.87 | — |
| PA06-e | 435 | 2.5 | 28.3 | 67.2 | 102.2 | 166.3 | 3.27 | — |
| PA06-f | 440 | 2.5 | 37.3 | 83.1 | 91.0 | 137.1 | 2.65 | — |
| PA01-a | 300 | 2.5 | 0.3 | — | 153.7 | 132.5 | 3.57 | — |
| PA01-b | 330 | 2.5 | 0.4 | — | 151.9 | 117.3 | 3.92 | — |
| PA01-c | 360 | 2.5 | 0.4 | — | 152.2 | 123.6 | 4.05 | — |
| PA01-d | 390 | 2.5 | 1.0 | — | 152.6 | 97.9 | 2.44 | — |
| PA06-g | 426 | 2.5 | 5.5 | — | 139.8 | 85.1 | 3.68 | — |
| PA06-h | 427 | 2.5 | 5.1 | — | 137.2 | 88.7 | 4.39 | — |
| PA06-i | 428 | 2.5 | 7.8 | — | 139.1 | 107.8 | 1.61 | — |
| PA06-j | 450 | 2.5 | 34.0 | — | 87.7 | 127.5 | 2.32 | — |
| PA06-k | 460 | 2.5 | 38.9 | — | 81.8 | 135.7 | 1.98 | — |
| PA06-l | 470 | 2.5 | 41.2 | — | 84.1 | 140.4 | 4.70 | — |

In the roll-to-roll heat treatment furnace, a temperature profile is formed in a direction of conveying a sample in the furnace, and heat treatment conditions are determined by a heater temperature and a conveying speed of the sample. As shown in Table 2, the heater temperatures of the samples PA02, PA03, and PA06 are 485° C., 435° C., and 425° C., respectively, and the conveying speeds are 1.0 m/min, 1.5 m/min, and 2.5 m/min, respectively. In the samples PA06a to PA061 and PAOla to PAOld, the conveying speed is 2.5 m/min, and the heater temperature is changed.

FIG. 2 is a diagram showing temperature changes during conveyance of the samples PA02, PA03, and PA06. The temperature is a temperature measured by a thermocouple having a diameter of 0.5 mm, when the thermocouple is sandwiched between stainless foils and the sample is conveyed in the apparatus A. As illustrated in FIG. 2, when the conveying speed is high, the holding period is short and the heating speed and the cooling speed are high.

From Table 1, the degree of crystallinity mainly depends on the heater temperature. When the heater temperature is high, the degree of crystallinity increases. When the heater temperature is equal, the degree of crystallinity is almost the same, like the comparison, for example, between the PA03 and the PA06-e, but the sample PA06-e having a high conveying speed has a slightly larger degree of crystallinity than the sample PA03.

FIG. 3 is a diagram showing a correlation between the XRD degree of crystallinity and the DSC degree of crystallinity. As shown in FIG. 3, the XRD degree of crystallinity and the DSC degree of crystallinity show a good correlation. By multiplying the DSC degree of crystallinity by 0.45, it can be converted into the XRD degree of crystallinity.

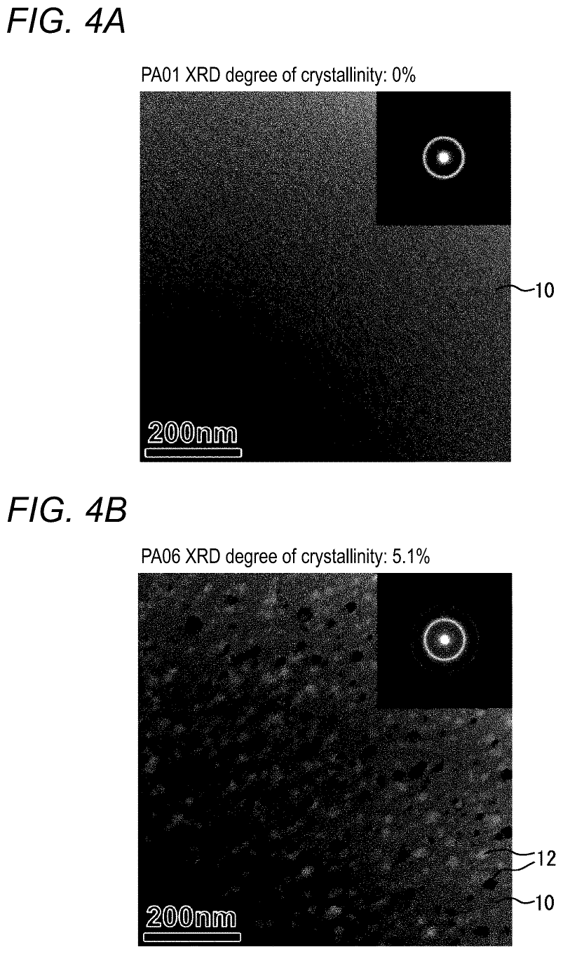

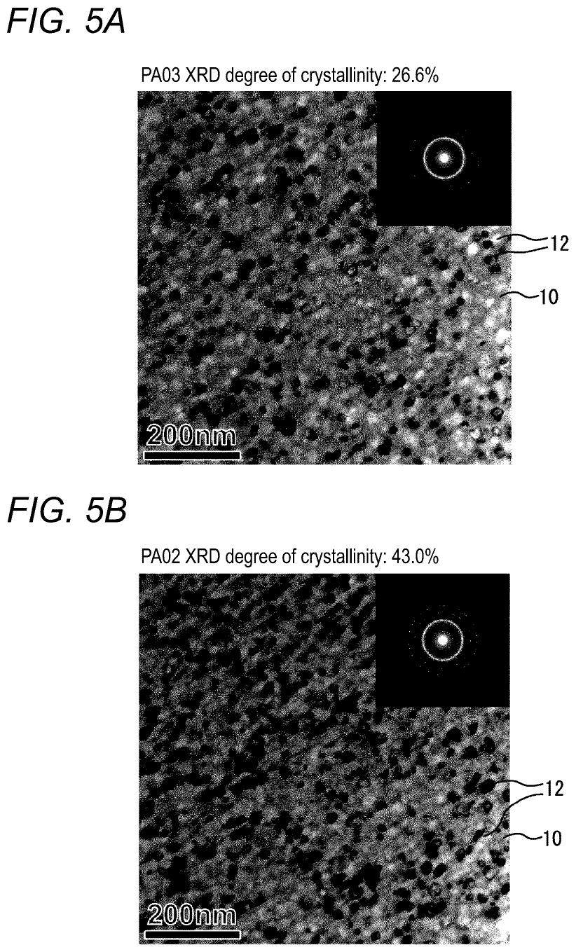

FIGS. 4A to 5B are transmission electron microscope (TEM) images and selected area electron diffraction (SAED) images of the samples PA01, PA06, PA03, and PA02, respectively. The top right figure of each diagram is an SAED image. In the sample PA01 not subjected to the heat treatment, the TEM image is almost uniformly gray, and no spot caused by the crystal is observed in the SAED image, as shown in FIG. 4A. The gray region in the TEM image is an amorphous phase 10.

In the sample PA06, a black or white crystalline phase 12 can be observed in the gray amorphous phase 10 in the TEM image, as shown in FIG. 4B. In the SAED image, weak spots are observed. In the TEM image of the sample PA03, more crystalline phases 12 in the amorphous phase 10 can be observed than the sample PA06, as shown in FIG. 5A. In the SAED image, stronger spots are observed than the sample PA06. In the TEM image of the sample PA02, more crystalline phases 12 in the amorphous phase 10 can be observed than the sample PA02, as shown in FIG. 5B. In the SAED image, stronger spots are observed than the FIG. 5A. As described above, the degree of crystallinity of the alloy can be changed depending on the temperature in the heat treatment.

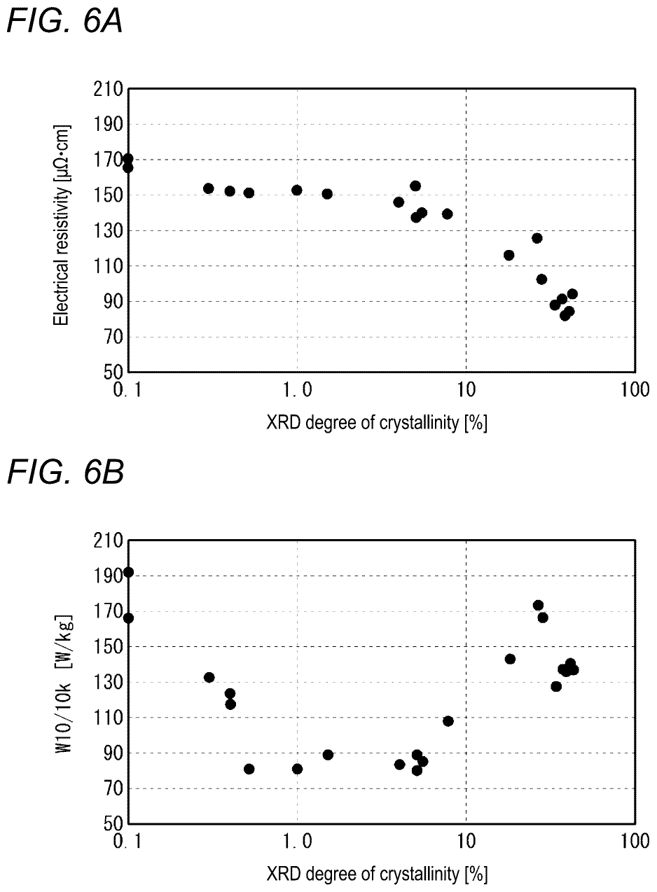

FIG. 6A is a diagram showing the electrical resistivity with respect to the XRD degree of crystallinity, while FIG. 6B is a diagram showing W10/10k with respect to the XRD degree of crystallinity. The W10/10k on the vertical axis corresponds to the iron loss at a maximum applied magnetic field Bm=1 T and a frequency f=10 kHz. The degree of crystallinity on the horizontal axis is expressed on a logarithmic scale, in which a sample having a degree of crystallinity of 0% is plotted with a degree of crystallinity of 0.1%.

When the degree of crystallinity is 0.1% or less, the electrical resistivity is about 170 μΩ·cm, as shown in FIG. 6A. A value obtained by normalizing the electrical resistivity using an electrical resistivity having a degree of crystallinity of nearly 0% is defined as a normalized electrical resistivity. When the degree of crystallinity is 0.3% or more and 4% or less, the electrical resistivity is about 150 μΩ·cm, and the normalized electrical resistivity is 150/170=0.88, which is nearly constant. When the degree of crystallinity is 5% and 8%, the electrical resistivity is about 140 μΩ·cm, and the normalized electrical efficiency is 140/170=0.82, which is slightly low. When the degree of crystallinity is 18%, the electrical resistivity is about 115 μΩ·cm, and the normalized resistivity is as low as 115/170=0.68. The assumed value of the electrical resistivity when the degree of crystallinity is 20% is about 110 μΩ·cm, and the normalized resistivity is 110/170=0.65. Thereafter, as the degree of crystallinity increases, the electrical resistivity decreases.

When the degree of crystallinity is 0.1% or less, W10/10k is about 170 to 190 W/kg, as shown in FIG. 6B. A value obtained by normalizing W10/10k using W10/10k=170 W/kg having a degree of crystallinity of nearly 0% is defined as normalized W10/10k. When the degree of crystallinity is 0.3% and 0.4%, W10/10k is 120 to 130 W/kg and the normalized W10/10k is 120 to 130/170=0.70 to 0.76. When the degree of crystallinity is 0.5% to 5%, W10/10k is 80 to 90 W/kg, and the normalized W10/10k is 80 to 90/170=0.47 to 0.53, which is nearly constant. When the degree of crystallinity is 8%, W10/10k is about 110 W/kg and the normalized W10/10k is 110/170=about 0.65. When the degree of crystallinity is 18%, W10/10k is about 145 W/kg and the normalized W10/10k is 145/170=about 0.85. When the degree of crystallinity is 26% to 28%, W10/10k is about 170 W/kg, and the normalized W10/10k is 170/170=about 1, which is almost the same as the alloy having a degree of crystallinity of 0%. When the degree of crystallinity is 30% or more, W10/10k decreases again.

From the above, when the degree of crystallinity is around 0%, the crystalline phase is scarcely formed, and thus the iron loss is large. When the degree of crystallinity is 0.3% or more, the crystalline phase is formed, and thus the iron loss reduces. When the degree of crystallinity is 0.3% to 5%, the electrical resistivity remains almost unchanged, and the iron loss remains almost unchanged. When the degree of crystallinity exceeds 5%, the electrical resistivity starts to decrease, and thus the iron loss starts to increase. When the degree of crystallinity exceeds 10%, the electrical resistivity further decreases and the iron loss increases. When the degree of crystallinity exceeds 20%, the electrical resistivity further decreases, and the iron loss is about the same as that of the amorphous alloy having a degree of crystallinity of 0%. It is considered that such a change in the iron loss depending on the degree of crystallinity may be caused by a change in the electrical resistivity. It is considered that the sudden decrease in the electrical resistivity when the degree of crystallinity is 10% to 20% may be caused by a percolation effect. When the degree of crystallinity exceeds 30%, the electrical resistivity further decreases. However, the iron loss is suppressed. This is considered to be because the saturation magnetic flux density increases as the degree of crystallinity increases.

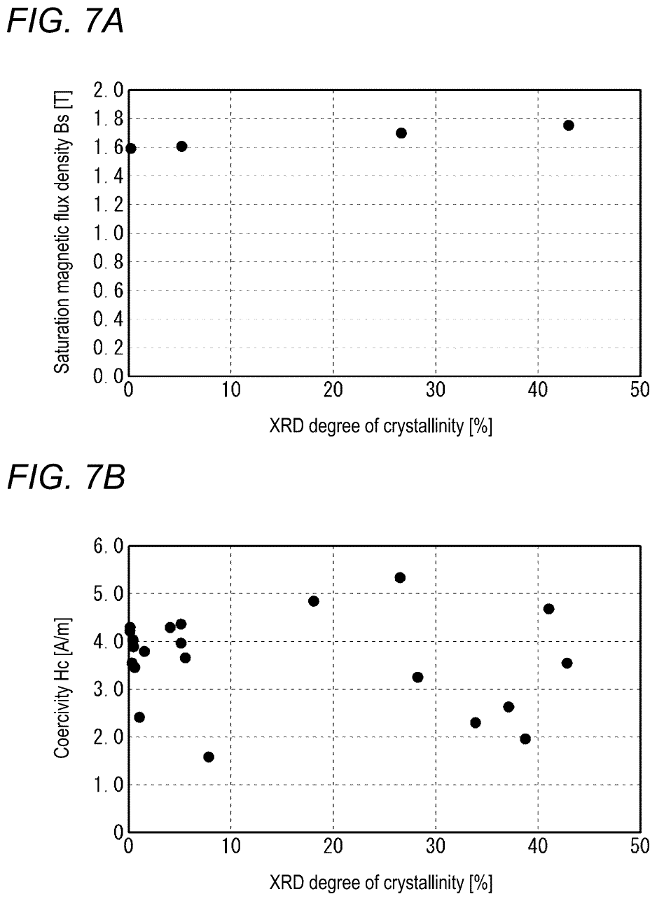

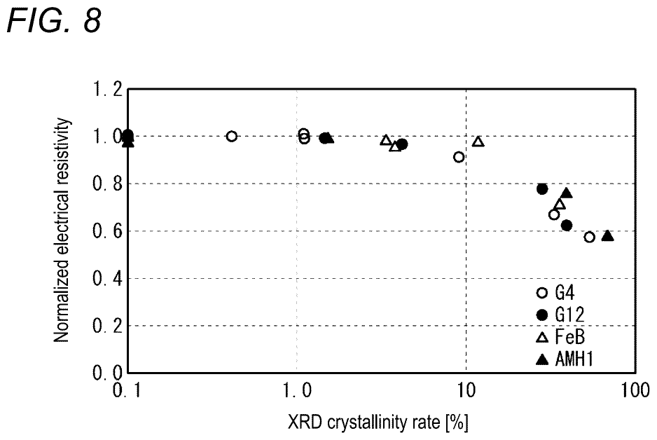

FIG. 7A is a diagram showing the saturation magnetic flux density Bs with respect to the XRD degree of crystallinity, while FIG. 7B is a diagram showing the coercivity Hc with respect to the XRD degree of crystallinity. As the degree of crystallinity decreases, the saturation magnetic flux density Bs decreases, as shown in FIG. 7A. However, even when the degree of crystallinity is 0%, the saturation magnetic flux density Bs is 1.6 T, and the saturation magnetic flux density Bs is larger than that of the Fe—Si—B—Nb—Cu alloy. The coercivity Hc varies from 1.6 A/m to 5.6 A/m, but the correlation between the degree of crystallinity and the coercivity Hc is small, as shown in FIG. 7B.

Samples were prepared using the apparatus B. Six samples of 10 mm×70 mm were stacked and placed in a tube furnace at room temperature. The temperature was raised to the attained temperature at a rate of 20° C./min, and held at the attained temperature for a holding period, and then the samples were taken out from the tube furnace and air-cooled.

Table 3 is a table showing the composition of the produced alloy in atom %.

TABLE 3

| Composition | Fe [atom %] | Si [atom %] | B [atom %] | P [atom %] | Cu [atom %] | C [atom %] |
|---|---|---|---|---|---|---|
| A | 84.8 | 0.5 | 9.4 | 3.5 | 0.8 | 1.0 |
| B | 84.3 | 0.5 | 10.9 | 3.0 | 0.7 | 0.6 |
| C | 83.2 | 2.7 | 10.2 | 3.1 | 0.7 | 0.1 |

As shown in Table 3, the composition of a composition A is almost the same as the composition in Table 1. In a composition B, B is increased by 1.5 atom %, and Fe, P, and C are reduced by 0.5 atom %, 0.5 atom %, and 0.4 atom %, respectively, compared to the composition A. In a composition C, Si is increased by 2.2 atom %, and Fe, B, and C are reduced by 1.1 atom %, 0.7 atom %, and 0.5 atom %, respectively, compared to the composition B.

Tables 4 and 5 show composition, preparation conditions of the prepared samples, degree of crystallinity, and W10/10k, coercivity Hc, and saturation magnetic flux density Bs. The samples having an attained temperature of 25° C. in Tables 4 and 5 were not subjected to heat treatment.

TABLE 4

| | | Attained | XRD degree of | | | |
|---|---|---|---|---|---|---|
| | Holding | temperature | crystallinity | W10/10k | Hc | Bs |
| Composition | period | [° C.] | [%] | [W/kg] | [A/m] | [T] |
| A | 60 min | 25 | 0.0 | 170.2 | 7.00 | 1.60 |
| A | 60 min | 225 | 1.7 | 91.4 | 11.39 | 1.62 |
| A | 60 min | 265 | 2.1 | 90.2 | 9.67 | 1.62 |
| A | 60 min | 305 | 2.5 | 94.8 | 14.84 | 1.63 |
| A | 60 min | 345 | 27.7 | 255.3 | 157.30 | 1.71 |
| A | 60 min | 385 | 51.0 | 359.7 | 132.90 | 1.75 |
| A | 12 h | 265 | 3.7 | 108.1 | 18.70 | 1.64 |

TABLE 5

| | | Attained | XRD degree of | | | |
|---|---|---|---|---|---|---|
| | Holding | temperature | crystallinity | W10/10k | Hc | Bs |
| Composition | period | [° C.] | [%] | [W/kg] | [A/m] | [T] |
| B | 60 min | 25 | 0.0 | 165.3 | 4.51 | 1.58 |
| B | 60 min | 265 | 2.5 | 82.8 | 5.27 | 1.62 |
| B | 60 min | 345 | 25.5 | 280.4 | 142.40 | 1.70 |
| C | 60 min | 25 | 0.0 | 154.2 | 3.78 | 1.53 |
| C | 60 min | 265 | 2.1 | 78.1 | 4.98 | 1.56 |
| C | 60 min | 345 | 23.6 | 219.6 | 142.40 | 1.69 |

In the sample of the composition A, when the holding period is set to 60 minutes and the attained temperature is raised, the degree of crystallinity increases, as shown in Table 4. In the sample having a degree of crystallinity of 1.7% to 2.5%, W10/10k is as small as about 100 W/kg, compared to the samples having a degree of crystallinity of 0% and 27.7% or more. The saturation magnetic flux density Bs decreases as the degree of crystallinity decreases, but is 1.6 T even when the degree of crystallinity is 0%. When the degree of crystallinity is 27.7% or more, the coercivity Hc is large. As described above, the tendencies of the W10/10k and saturation magnetic flux density Bs with respect to the degree of crystallinity of the sample of the composition A are the same in Table 2 and Table 4 in which the heat treatment methods are different.

When the sample having an attained temperature of 265° C. and a holding period of 60 minutes is compared to the sample having a holding period of 12 hours, the degree of crystallinity increases from 2.1% to 3.7% by extending the holding period. The saturation magnetic flux densities Bs and W10/10ks remain almost unchanged between the sample having a holding period of 60 minutes and the sample having a holding period of 12 hours.

In compositions B and C, W10/10k is about 100 W/kg when the degree of crystallinity is 2.1 to 2.5%, as shown in Table 5. The saturation magnetic flux density Bs decreases as the degree of crystallinity decreases, but is 1.53 T even when the degree of crystallinity is 0%. When the degree of crystallinity is 23.6% or more, the coercivity Hc is large. As described above, the tendencies of the W10/10k and saturation magnetic flux density Bs with respect to the degree of crystallinity are the same among the compositions A to C having different compositions.

As described above, when the degree of crystallinity is 0.3% or more and 20% or less, the saturation magnetic flux density can be increased and the iron loss can be suppressed regardless of the production method and composition.

### Example 2

As an example 2, a sample containing no Si, P, and Cu was prepared. The method for producing an amorphous alloy is the same as that in the example 1.

### [Production Conditions]

Production apparatus: Tube furnace
Holding time: 30 minutes
Heating rate: 40° C./sec to 70° C./sec
Degree of vacuum: 10⁻³ MPa or less

A quartz tube in which a sample is sealed and brought into a vacuum state is inserted into a tube furnace set to a target temperature. After the holding time elapsed, the quartz tube in the tube furnace was taken out.

### [Method for MeasuringDegree of Crystallinity by XRD Method (XRDDegree of Crystallinity)]

Measuring apparatus: MiniFlex600 manufactured by Rigaku Corporation
X-ray source: Cr
2θ range: 40° to 140°
2θ scan step: 0.01°
Sample size: 10 mm×70 mm
Measurement surface: Roll surface

### [Method for Measuring Iron Loss]

Measuring apparatus: SY-8219, SY-956 manufactured by IWATSU ELECTRIC CO., LTD.
Primary winding: 40 T
Secondary winding: 35 T
Frequency: 10 kHz
Magnetic flux density: 1.0 T
Sample size: 10 mm×70 mm

### [Method for Measuring Saturation Magnetic Flux Density]

Measuring apparatus: VSM-P7-15 manufactured by Toei Industry Co., Ltd.
Applied magnetic field: 955 kA/m
Sample size: 8 mm×8 mm

### [Method for Measuring Coercivity]

Measuring apparatus: BHS-40 manufactured by Riken Denshi Co., Ltd.
Applied magnetic field: 2000 A/m
Sample size: 10 mm×70 mm

### [Method for Measuring Electrical Resistivity]

Measuring apparatus: RM3545 manufactured by HIOKI E.E. CORPORATION
4-terminal probe: RM9010-2
Probe interval: 1.5 mm

Samples were prepared for five compositions. Table 6 is a table showing the compositions and thicknesses of the prepared alloys.

TABLE 6

| | Composition [atom %] | | | | | | | Thickness |
|---|---|---|---|---|---|---|---|---|
| Sample | Fe | Si | B | P | Nb | Cu | C | [μm] |
| G4 | 85.3 | 2.0 | 8.0 | 4.0 | — | 0.7 | — | 22 |
| G12 | 85.3 | — | 12.0 | 2.0 | — | 0.7 | — | 20 |
| FeB | 86.0 | — | 14.0 | — | — | — | — | 2261 |
| AMH1 | 81.5 | 4.0 | 14.0 | — | — | — | 0.5 | 25 |
| FT | 73.5 | 13.5 | 9.0 | — | 3.0 | 1.0 | — | 18 |

As shown in Table 6, a sample G4 contains Fe, Si, B, P, and Cu, which corresponds to the example 1. A sample G12 contains Fe, B, P, and Cu, and does not contain Si. A sample FeB contains Fe and B, and does not contain Si, P, and Cu. A sample AMH1 contains Fe, Si, and B, and does not contain P and Cu. A sample FT contains Nb in addition to Fe, Si, B, P, and Cu, but the composition of Fe is as low as 73.5 atom %.

Tables 7 to 11 show the attained temperature, degree of crystallinity, electrical resistivity, W10/10k, coercivity Hc, and saturation magnetic flux density Bs of each of the prepared samples G4, G12, FeB, AMH1, and FT. A sample AsQ is in the state of an amorphous alloy, and is not subjected to heat treatment.

TABLE 7

| | Attained | XRD degree of | Electrical | | | |
|---|---|---|---|---|---|---|
| | temperature | crystallinity | resistivity | W10/10k | Hc | Bs |
| Sample | [° C.] | [%] | [μΩ · cm] | [W/kg] | [A/m] | [T] |
| AsQ | 25 | 0.1 | 125.6 | 329.0 | | |
| G4_280 | 280 | 0.4 | 126.0 | 243.1 | 17.95 | 1.58 |
| G4_300 | 300 | 1.1 | 127.5 | 204.6 | 25.65 | 1.58 |
| G4_320 | 320 | 1.1 | 125.4 | 186.0 | 39.14 | 1.57 |
| G4_340 | 340 | 8.9 | 115.4 | 330.5 | 52.38 | 1.58 |
| G4_360 | 360 | 32.9 | 84.8 | 654.2 | 121.00 | 1.74 |
| G4_370 | 370 | 53.4 | 73.0 | 694.0 | 104.00 | 1.80 |

TABLE 8

| | Attained | XRD degree of | Electrical | | | |
|---|---|---|---|---|---|---|
| | temperature | crystallinity | resistivity | W10/10k | Hc | Bs |
| Sample | [° C.] | [%] | [μΩ · cm] | [W/kg] | [A/m] | [T] |
| AsQ | 25 | 0.1 | 130.4 | 274.8 | | |
| G12_280 | 280 | 0.1 | 131.0 | 171.0 | 6.96 | 1.59 |
| G12_300 | 300 | 0.1 | 131.4 | 142.4 | 4.64 | 1.58 |
| G12_320 | 320 | 1.5 | 130.0 | 146.8 | 2.96 | 1.58 |
| G12_340 | 340 | 4.2 | 126.5 | 140.9 | 6.03 | 1.60 |
| G12_360 | 360 | 27.9 | 101.9 | 890.5 | 153.70 | 1.65 |
| G12_370 | 370 | 39.2 | 81.9 | 1032.2 | 176.50 | 1.77 |

TABLE 9

| | Attained | XRD degree of | Electrical | | | |
|---|---|---|---|---|---|---|
| | temperature | crystallinity | resistivity | W10/10k | Hc | Bs |
| Sample | [° C.] | [%] | [μΩ · cm] | [W/kg] | [A/m] | [T] |
| AsQ | 25 | 0.1 | 122.4 | 329.0 | | |
| FeB_270 | 270 | 0.1 | 121.8 | 225.1 | 4.99 | 1.55 |
| FeB_290 | 290 | 3.3 | 121.2 | 192.2 | 4.63 | 1.55 |
| FeB_310 | 310 | 3.8 | 117.8 | 189.0 | 3.18 | 1.56 |
| FeB_330 | 330 | 11.6 | 120.1 | 201.4 | 5.95 | 1.56 |
| FeB_350 | 350 | 35.3 | 88.1 | 1480.4 | 284.80 | 1.69 |

TABLE 10

| | Attained | XRD degree of | Electrical | | | |
|---|---|---|---|---|---|---|
| | temperature | crystallinity | resistivity | W10/10k | Hc | Bs |
| Sample | [° C.] | [%] | [μΩ · cm] | [W/kg] | [A/m] | [T] |
| AsQ | 25 | 0.1 | 123.7 | 195.8 | | |
| AMH1_360 | 360 | 0.1 | 125.1 | 164.1 | 0.87 | 1.61 |
| AMH1_370 | 370 | 0.1 | 120.0 | 165.6 | 1.15 | 1.62 |
| AMH1_390 | 390 | 0.1 | 121.6 | 152.6 | 3.21 | 1.61 |
| AMH1_420 | 420 | 1.5 | 123.2 | 122.8 | 16.45 | 1.61 |
| AMH1_450 | 450 | 38.9 | 94.2 | 5820 | 1222 | 1.68 |
| AMH1_480 | 480 | 68.5 | 72.3 | 7993 | 1127 | 1.69 |

TABLE 11

| | Attained | XRD degree of | Electrical | | | |
|---|---|---|---|---|---|---|
| | temperature | crystallinity | resistivity | W10/10k | Hc | Bs |
| Sample | [° C.] | [%] | [μΩ · cm] | [W/kg] | [A/m] | [T] |
| AsQ | 25 | 0.1 | 146.5 | 414.4 | | |
| FT310 | 310 | 0.1 | 139.2 | 434.8 | 8.98 | 1.26 |
| FT350 | 350 | 0.1 | 144.9 | 325.1 | 6.17 | 1.26 |
| FT390 | 390 | 0.1 | 143.7 | 248.8 | 3.77 | 1.26 |
| FT430 | 430 | 0.1 | 146.3 | 173.6 | 2.45 | 1.26 |
| FT470 | 470 | 0.1 | 147.5 | 165.4 | 2.34 | 1.27 |
| FT490 | 490 | 2.6 | 139.3 | 118.9 | 2.02 | 1.26 |
| FT510 | 510 | 32.0 | 138.2 | 122.5 | 1.01 | 1.24 |

In any of the samples G4, G12, FeB, AMH1, and FT, the holding force Hc is favorably 100 A/m or less when the XRD degree of crystallinity is in the range of 0.3% or more and 20% or less, as shown in Tables 8 to 11. In particular, when the XRD degree of crystallinity is in the range of 0.3% or more and 8% or less, the holding force Hc is favorably 40 A/m or less.

In the samples G4, G12, FeB, and AMH1, the saturation magnetic flux densities Bs are favorably 1.5 T or more. In the sample FT, the saturation magnetic flux density is as low as 1.3 T or less. This is because the composition of Fe in the sample FT is as low as 73.5 atom %.

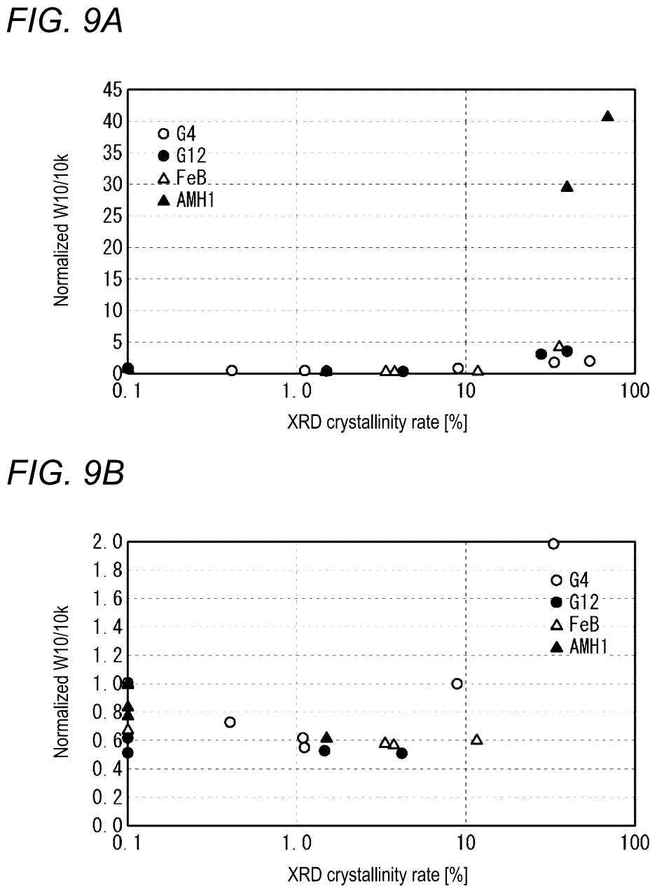

FIG. 8 is a diagram showing normalized electrical resistivities with respect to the XRD degrees of crystallinity in the samples G4, G12, FeB, and AMH1. FIGS. 9A and 9B are diagrams showing normalized W10/10ks with respect to the XRD degrees of crystallinity. FIG. 9B is a diagram in which the vertical axis of FIG. 9A is enlarged. The normalized electrical resistivity and the normalized W10/10k are normalized with respect to those of AsQ in each of the samples G4, G12, FeB, and AMH1. The dots indicate measurement points.

In any of the samples G4, G12, FeB, and AMH1, the normalized electrical resistivity is almost 1 when the XRD crystallinity rate is from 0.1% to 10%, as shown in FIG. 8. When the XRD crystallinity rate is about 30%, the normalized electrical resistivity decreases to about 0.8. When the XRD crystallinity rate is in the range of 0.3% or more and 20% or less, the normalized electrical resistivity is 0.65 or more, as described above.

In any of the samples G4, G12, FeB, and AMH1, the normalized W10/10k is 1 or less when the XRD crystallinity rate is from 0.1% to 10%, as shown in FIGS. 9A and 9B. When the XRD crystallinity rate is about 30%, the normalized 10/10k exceeds 1, and when the XRD crystallinity rate increases, the normalized 10/10k greatly increases.

Also in the samples: G12 containing no Si; FeB containing no Si, P, and Cu; and AMH1 containing no P and Cu, as in the example 2, the iron loss can be suppressed when the XRD degree of crystallinity is 0.3% or more and 20% or less, similarly to the sample G4 containing Fe, Si, B, P, and Cu. In addition, the saturation magnetic flux density Bs can be increased.

Although the preferred embodiments of the present invention have been described in detail above, the present invention is not limited to the specific embodiments, and various modifications and changes can be made within the scope of the gist of the present invention described in the claims.

### REFERENCE SIGNS LIST

10: Amorphous phase, and 12: Crystalline phase

1. An alloy containing Fe and B,
the alloy comprising an amorphous phase and a plurality of α-Fe crystalline phases formed in the amorphous phase, wherein
an average Fe concentration in the entire alloy is 79 atom % or more, and
a degree of crystallinity measured using an X-ray diffraction method is 0.3% or more and 20% or less.

2. The alloy according to claim 1, wherein
the average Fe concentration in the entire alloy is 79.0 atom % or more and 86.0 atom % or less,
an average B concentration in the entire alloy is 5.0 atom % or more and 14.0 atom % or less,
an average Si concentration in the entire alloy is 0.0 atom % or more and 8.0 atom % or less,
an average P concentration in the entire alloy is 0.0 atom % or more and 8.0 atom % or less,
an average C concentration in the entire alloy is 0.0 atom % or more and 5.0 atom % or less, and
an average Cu concentration in the entire alloy is 0.0 atom % or more and 1.4 atom % or less.

3. The alloy according to claim 2, wherein
an average impurity concentration of impurities other than Fe, Cu, P, B, Si, and C in the entire alloy is 0 atom % or more and 0.3 atom % or less, and
a sum of the average Fe concentration, the average Cu concentration, the average P concentration, the average B concentration, the average Si concentration, the average C concentration, and the average impurity concentration is 100.0 atom %.

4. The alloy according to claim 1, wherein
the average Fe concentration in the entire alloy is 79.0 atom % or more and 86.0 atom % or less,
the average B concentration in the entire alloy is 5.0 atom % or more and 14.0 atom % or less,
the average Si concentration in the entire alloy is 0.0 atom % or more and 8.0 atom % or less,
the average P concentration in the entire alloy is 1.0 atom % or more and 8.0 atom % or less,
the average C concentration in the entire alloy is 0.0 atom % or more and 5.0 atom % or less, and
the average Cu concentration in the entire alloy is 0.4 atom % or more and 1.4 atom % or less.

5. The alloy according to claim 4, wherein a ratio of the average Cu concentration to the average P concentration is 0.08 or more and 0.8 or less.

6. The alloy according to claim 4, wherein
the average impurity concentration of impurities other than Fe, Cu, P, B, Si, and C in the entire alloy is 0 atom % or more and 0.3 atom % or less, and
the sum of the average Fe concentration, the average Cu concentration, the average P concentration, the average B concentration, the average Si concentration, the average C concentration, and the average impurity concentration is 100.0 atom %.

7. The alloy according to claim 6, wherein an electrical resistivity of the alloy is 0.65 times or more an electrical resistivity of an alloy having the degree of crystallinity of 0%.

8. The alloy according to claim 6, wherein the degree of crystallinity is 0.5% or more and 8% or less.

9. The alloy according to claim 1, wherein the alloy has a powder shape or a strip shape.

10. The alloy according to claim 2, wherein the alloy has a powder shape or a strip shape.

11. The alloy according to claim 3, wherein the alloy has a powder shape or a strip shape.

12. The alloy according to claim 4, wherein the alloy has a powder shape or a strip shape.

13. The alloy according to claim 5, wherein the alloy has a powder shape or a strip shape.

14. The alloy according to claim 6, wherein the alloy has a powder shape or a strip shape.

15. The alloy according to claim 7, wherein the alloy has a powder shape or a strip shape.

16. The alloy according to claim 8, wherein the alloy has a powder shape or a strip shape.
